(19) United States
(12) Patent Application Publication
(10) Pub. No.: US 2013/0201171 A1
(43) Pub. Date: Aug. 8, 2013

(54) DISPLAY DEVICE AND DRIVING METHOD THEREOF

(71) Applicant: June-Young Song, Yongin-City (KR)

(72) Inventor: June-Young Song, Yongin-City (KR)

(73) Assignee: Samsung Mobile Display Co., Ltd., Yongin-City (KR)

(21) Appl. No.: 13/475,757

(22) Filed: May 18, 2012

(30) Foreign Application Priority Data
Feb. 6, 2012 (KR) 10-2012-0011875

(51) Int. Cl. G09G 5/00

(52) U.S. Cl. 345/212

(57) ABSTRACT

A display device for preemptively preventing an error caused by a fault in the scan circuit is disclosed. In one aspect, it includes: a display including a plurality of pixels connected to a plurality of scan lines and a plurality of data lines, a scan driver for sequentially applying a plurality of scan signals to the scan lines, and a signal controller for controlling the scan driver. In addition, the signal controller receives a final scan signal that is output for the last time from among the scan signals from the scan driver, detects output timing of the final scan signal, and determines whether the scan driver is normally driven. Accordingly, a display error caused by a fault of the scan circuit can be preemptively prevented.

### CROSS-REFERENCE TO RELATED APPLICATIONS

This application claims priority to and the benefit of Korean Patent Application No. 10-2012-0011875 filed in the Korean Intellectual Property Office on Feb. 6, 2012, the entire contents of which are incorporated herein by reference.

### BACKGROUND OF THE INVENTION

1. Field of the Invention

The disclosed technology relates to a display device and a driving method thereof. More particularly, it relates to a display device for preemptively preventing an error caused by a fault in a scan circuit, and a driving method thereof.

2. Description of the Related Art

The display area of a display device includes a plurality of pixels connected to a plurality of scan lines and a plurality of data lines that are arranged in an array. The display device sequentially applies a scan signal with a gate on voltage to the scan lines so as to display an image, and applies a data signal corresponding to the scan signal with the gate on voltage to the data lines.

When the display device is manufactured or during its operation, a fault (e.g., a short circuit) may be generated in a scan circuit that generates the scan signal. When the scan circuit includes a fault, the image be improperly displayed. When a process line inspector of the display device or user continuously supplies power to the display device and attempts to operate the device in the presence of the fault, other drive circuits such as a timing controller or a power supply circuit may be negatively impacted.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

According to some embodiments, a display device is disclosed. The display device includes a display including a plurality of pixels connected to a plurality of scan lines and a plurality of data lines, a scan driver configured to sequentially apply a plurality of scan signals to the scan lines, and a signal controller configured to control the scan driver, receive a final scan signal from among the scan signals that is output by the scan driver, detect output timing of the final scan signal, and determine an error based on the detected output timing.

According to some embodiments, a method for driving a display device is disclosed. The method includes outputting a plurality of scan signals via a scan driver to a plurality of scan lines that are connected to a plurality of pixels, receiving a final scan signal that is output from among the scan signals, and detecting output timing of the final scan signal; and determining an error based on the detected output timing.

### BRIEF DESCRIPTION OF THE DRAWINGS

FIG. 1 shows a block diagram of a display device according to some embodiments.

FIG. 2 shows a block diagram of a configuration of a display device for preventing a display error according to some embodiments.

FIG. 3 shows a timing diagram for a driving method when a scan circuit of a display device according to some embodiments is normally driven.

FIG. 4 shows a timing diagram for a driving method when a scan circuit of a display device according to some embodiments is abnormally driven.

### DETAILED DESCRIPTION OF CERTAIN INVENTIVE EMBODIMENTS

The present invention will be described more fully hereinafter with reference to the accompanying drawings, in which some embodiments of the invention are shown. As those skilled in the art would realize, the described embodiments may be modified in various different ways, all without departing from the spirit or scope of the present invention.

Further, in the embodiments, like reference numerals designate like elements throughout the specification representatively in a first embodiment, and only elements other than those of the first embodiment will be subsequently described.

Accordingly, the drawings and description are to be regarded as illustrative in nature and not restrictive, and like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

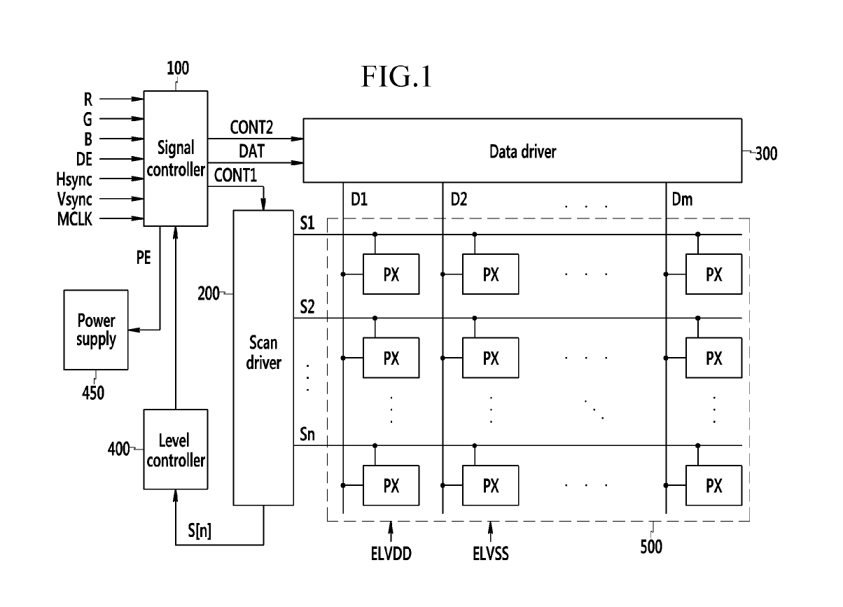

FIG. 1 shows a block diagram of a display device according to some embodiments.

With reference to FIG. 1, the display device includes a signal controller 100, a scan driver 200, a data driver 300, a level controller 400, a power supply 450, and a display 500.

The signal controller 100 receives video signals (R, G, B) and an input control signal for controlling displaying of the video signals (R, G, B) from an external device. The video signals (R, G, B) have luminance information of respective pixels (PX). For example, the luminance may have grayscales of 1024=2¹⁰, 256=2⁸, or 64=2⁶. The input control signal may include a vertical synchronization signal (Vsync), a horizontal synchronization signal (Hsync), a main clock signal (MCLK), and a data enable signal (DE).

The signal controller 100 processes the input video signals (R, G, B) according to an operational condition of the display 500 and the data driver 300 based on the input control signal, and generates a scan control signal (CONT1), a data control signal (CONT2), and an image data signal (DAT). The signal controller 100 transmits the scan control signal (CONT1) to the scan driver 200. The signal controller 100 transmits the data control signal (CONT2) and the image data signal (DAT) to the data driver 300.

The display 500 includes a plurality of scan lines (S1-Sn), a plurality of data lines (D1-Dm), and a plurality of pixels (PX) connected to the signal lines (S1-Sn) and data lines (D1-Dm). The pixels may be arranged in an array, such as a matrix as shown in FIG. 1. The scan lines S1-Sn may extend substantially along a row direction and may be substantially parallel with each other. The data lines D1-Dm may extend substantially along a column direction and may also be substantially parallel with each other. The pixels (PX) of the display 500 receive a first power source voltage (ELVDD) and a second power source voltage (ELVSS) from an external device.

The scan driver 200 is connected to the scan lines (S1-Sn). The scan driver 200 is configured to apply a scan signal that is a combination of a gate on voltage (Von) for turning on application of the data signal to the pixel (PX) and a gate off voltage (Voff) for turning off the same to the scan lines (S1-Sn) according to the scan control signal (CONT1).

The scan control signal (CONTI) includes a scan start signal (SSP) and a clock signal (SCLK). The scan start signal (SSP) generates a first scan signal for displaying an image of one frame. The clock signal (SCLK) represents a synchronization signal for sequentially applying the scan signal to the scan lines (S1-Sn).

The data driver 300 is connected to the data lines D1-Dm, and selects a gray voltage according to the image data signal (DAT). The data driver 300 applies the gray voltage that is selected according to the data control signal (CONT2) to the data lines (D1-Dm) as a data signal.

The level controller 400 controls a voltage level of a final scan signal (S[n]) that is finally output from among a plurality of scan signals that are output by the scan driver 200 and transmits it to the signal controller 100. The level controller 400 transforms the voltage level of the final scan signal (S[n]) into a voltage level (e.g., 3.3 V) used by the signal controller 100, and transmits it to the signal controller 100.

The signal controller 100 detects an output timing of the final scan signal (S[n]) transmitted through the level controller 400 and determines whether the scan driver 200 is normally driven. The signal controller 100 determines that the scan driver 200 is normally driven when the final scan signal (S[n]) is output at a reference time or within a reference time window. According to some embodiments, the signal controller 100 determines that the scan driver 200 is abnormally driven when the final scan signal (S[n]) is not output at the reference time or is output at a time other than the reference time. According to some embodiments, the signal controller 100 may be configured to calculate a time difference between the output of a scan signal (e.g., a first scan signal S[1]) and the last scan signal S[n]. The signal controller 100 may then compare the calculated time difference with a reference time value or reference time window to determine the scan driver 200 is abnormally driven.

The signal controller 100 applies a power enable (PE) signal to the power supply 450. The signal controller 100 can apply the power enable (PE) signal as an ON voltage when the scan driver 200 is normally driven. The signal controller 100 can apply the power enable (PE) signal as an OFF voltage when the scan driver 200 is abnormally driven.

The power supply 450 supplies power for operating driving devices including the signal controller 100, the scan driver 200, and the data driver 300. The power supply 450 can supply a first power source voltage (ELVDD) and a second power source voltage (ELVSS) to the display 500.

The power supply 450 continues to supply power to the signal controller 100, the scan driver 200, and the data driver 300 when the power enable (PE) signal is applied as the ON voltage. The power supply 450 continues to supply the first power source voltage (ELVDD) and the second power source voltage (ELVSS) when the power enable (PE) signal is applied as the ON voltage.

The power supply 450 is configured to intercept (e.g., halt) the power that is supplied to the signal controller 100, the scan driver 200, and the data driver 300 when the power enable (PE) signal is applied as the OFF voltage. The power supply 450 is configured to stop the first power source voltage (ELVDD) and the second power source voltage (ELVSS) from being supplied to the display 500 when the power enable (PE) signal is applied as the OFF voltage.

The above-described driving devices (100, 200, 300, 400, 450) may be installed in an external part of a pixel area as at least one integrated circuit chip, installed on a flexible printed circuit film, attached in a tape carrier package (TCP) form to the display 500, installed on a printed circuit board, or integrated in the external part of the pixel area together with the signal lines (S1-Sn, D1-Dm).

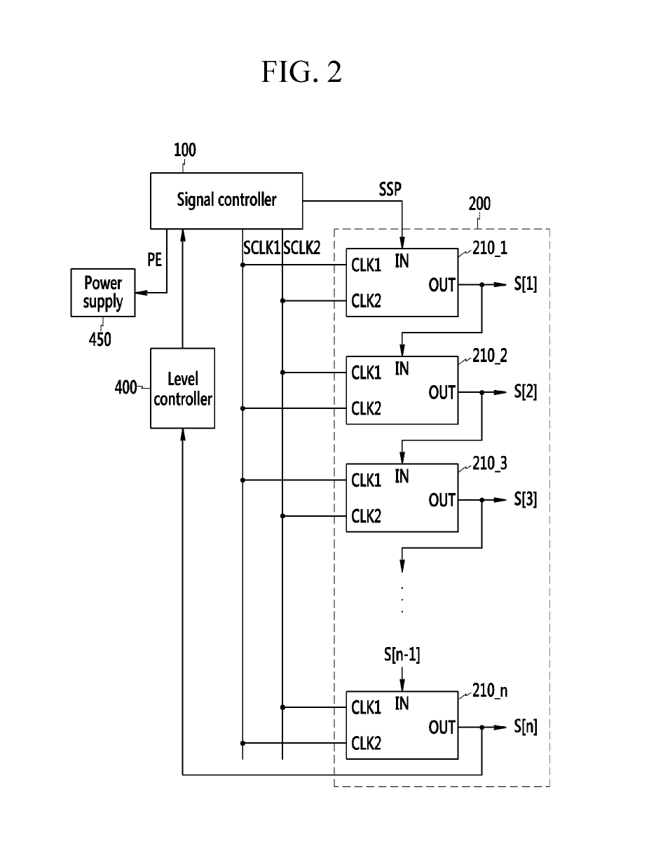

FIG. 2 shows a block diagram of a configuration of a display device for preventing a display error according to some embodiments.

With reference to FIG. 2, the scan driver 200 includes a plurality of scan drive blocks (210_1, 210_2, 210_3, . . . , 210_n) that are sequentially arranged. The scan drive blocks (210_1, 210_2, 210_3, . . . , 210_n) generate scan signals (S[1], S[2], S[3], . . . , S[n]) that are transmitted to the scan lines (S1-Sn).

The scan drive blocks (210_1, 210_2, 210_3, . . . , 210_n) respectively include a first clock signal input terminal (CLK1), a second clock signal input terminal (CLK2), an input signal input terminal (IN), and an output terminal (OUT).

The first clock signal (SCLK1) is input to the first clock signal input terminal (CLK1) of odd-numbered scan drive blocks (210_1, 210_3, . . . ), and the second clock signal (SCLK2) is input to the second clock signal input terminal (CLK2) thereof from among the scan drive blocks (210_1, 210_2, 210_3, . . . , 210_n).

The second clock signal (SCLK2) is input to the first clock signal input terminal (CLK1) of even-numbered scan drive blocks (210_2, . . . , 210_n), and the first clock signal (SCLK1) is input to the second clock signal input terminal (CLK2) thereof from among the scan drive blocks (210_1, 210_2, 210_3, . . . , 210_n).

The scan drive blocks (210_1, 210_2, 210_3, . . . , 210_n) sequentially output scan signals (S[1], S[2], S[3], . . . , S[n]) in synchronization with signals that are input to the first clock signal (SCLK1), the second clock signal (SCLK2), and the input signal input terminal (IN). The final scan signal (S[n]) that is output by the final scan drive block (210_n) is transmitted to the level controller 400.

The level controller 400 transforms the voltage level of the final scan signal (S[n]) into a voltage level appropriate for the signal controller 100, and transmits it to the signal controller 100.

The signal controller 100 detects timing of the final scan signal (S[n]) transmitted through the level controller 400 to determine whether the scan driver 200 is normally driven. The signal controller 100 applies the power enable (PE) signal as the ON voltage or the OFF voltage depending on whether the scan driver 200 is normally driven or not.

Embodiments of the scan driver 200 are not limited to a configuration in which a plurality of scan drive blocks (210_1, 210_2, 210_3, . . . , 210_n) included in the scan driver 200 use two clock signals (SCLK1, SCLK2) to sequentially output the scan signals (S[1], S[2], S[3], . . . , S[n]). Rather, the scan driver 200 can be configured in various manners so as to sequentially output the scan signal by using at least two clock signals.

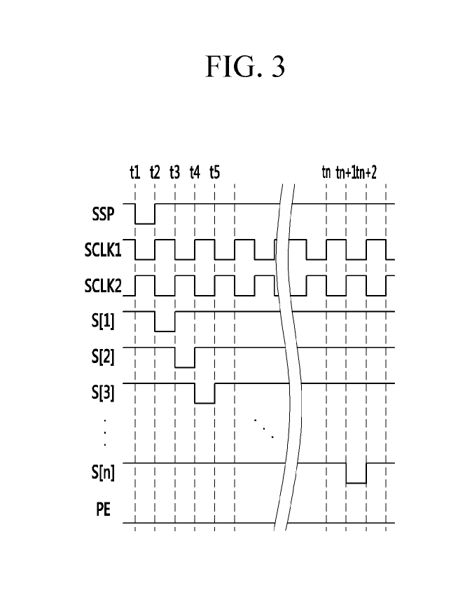

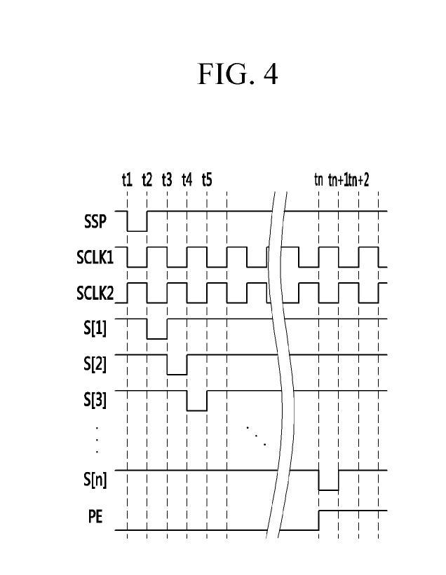

When the scan driver 200 of the display device is configured in a like manner of FIG. 2, the case in which the scan driver 200 is normally driven will be described with reference to FIG. 3, and the case in which the scan driver 200 is abnormally driven because of a circuit fault or a power short circuit will be described with reference to FIG. 4.

FIG. 3 shows a timing diagram for a driving method when a scan circuit of a display device according to some embodiments is normally driven.

With reference to FIG. 3, illustrates an example in which a plurality of scan drive blocks (210_1, 210_2, 210_3, . . . , 210_n) included in the scan driver 200 of FIG. 2 include p-channel field effect transistors, a logic low-level signal represents a gate on signal for driving the scan drive block, and the scan drive blocks (210_1, 210_2, 210_3, . . . , 210_n) sequentially output logic low-level scan signals (S[1], S[2], S[3], . . . , S[n]). The signal controller 100 as shown in FIG. 3 is configured to output a logic low-level voltage as an ON-voltage power enable (PE) signal and a logic high-level voltage as an OFF-voltage power enable (PE) signal. A person having ordinary skill in the art will recognize that other components such as n-channel field effect transistors may be used. Further, a logic high-level signal may represent a gate on signal for driving the scan drive block, and the scan drive blocks may sequentially output logic high-level scan signals.

A scan start signal (SSP) is input to the input signal input terminal (IN) of the first scan drive block 210_1, the first clock signal (SCLK1) is input to the first clock signal input terminal (CLK1), and the second clock signal (SCLK2) is input to the second clock signal input terminal CLK2. The first scan drive block 210_1 outputs a logic low-level scan signal (S[1]) during an interval t2-t3.

With reference to the second scan drive block 210_2, a scan signal (S[1]) of the first scan drive block 210_1 is input to the input signal input terminal (IN), the second clock signal (SCLK2) is input to the first clock signal input terminal CLK1, and the first clock signal (SCLK1) is input to the second clock signal input terminal (CLK2). The second scan drive block 210_2 outputs a logic low-level scan signal (S[2]) during an interval t3-t4.

In a like manner, logic low-level scan signals (S[1], S[2], S[3], . . . , S[n]) are sequentially output, and the final scan drive block 210_n that is arranged at the last time outputs a logic low-level scan signal (S[n]) during intervals tn+1 to tn+2. A logic low-level scan signal (S[n]) of the final scan drive block 210_n may be referred to as a final scan signal.

The signal controller 100 may calculate a reference time (tn+1 to tn+2) in which the final scan signal (S[n]) is output based a number of the scan lines S1-Sn. The signal controller 100 maintains the power enable (PE) signal at the ON voltage, and then outputs the power enable (PE) signal as the OFF voltage when the final scan signal (S[n]) is detected at a time other than the reference time (tn+1 to tn+2).

For example, as shown in FIG. 3, the final scan signal (S[n]) is output within the time period corresponding to the reference times (tn+1 to tn+2) such that the signal controller 100 maintains the power enable (PE) signal at the ON voltage.

FIG. 4 shows a timing diagram for a driving method when a scan circuit of a display device according to some embodiments is abnormally driven.

With reference to FIG. 4, unlike FIG. 3, the final scan signal (S[n]) is output not at the reference time (tn+1 to tn+2) but at an interval (tn to tn+1). The signal controller 100 maintains the power enable (PE) signal at the ON voltage, and then outputs the power enable (PE) signal as the OFF voltage when the final scan signal (S[n]) is detected at a time to other than the reference time (tn+1 to tn+2).

The power enable (PE) signal is output as the OFF voltage so the power supply 450 is disabled. The power supply 450 is disabled so as to stop power from being supplied to the signal controller 100, the scan driver 200, and the data driver 300. For example, as the power supply 450 is disabled, the display device is switched to an off state.

In a conventional example, when a scan driver 200 includes a fault or a power short circuit, and the display device is forcibly driven, the signal controller 100, the data driver 300, and the power supply 450 may operate in an erroneous manner. In the presence of a fault, a short circuit voltage may be input to cause a problem with other driving devices such as the signal controller 100, the data driver 300, and the power supply 450.

However, according to the embodiments described above the display device receives the final scan signal (S[n]) of the scan driver 200 to determine whether the scan driver 200 is normally driven, and when the scan driver 200 includes a fault, the display device preemptively stops power supplied to the components to prevent errors in other components such as the signal controller 100, the data driver 300, and the power supply 450.

The disclosed embodiments describe a display device for preemptively preventing a display error caused by a fault of a scan circuit, and a driving method thereof.

According to some embodiments, a display device includes a display including a plurality of pixels connected to a plurality of scan lines and a plurality of data lines, a scan driver for sequentially applying a plurality of scan signals to the scan lines, and a signal controller configured to control the scan driver, receive a final scan signal that is output for the last time from among the scan signals from the scan driver, and detect the output timing of the final scan signal, and determine whether the scan driver is normally driven.

The display device further includes a level controller configured to control a voltage level of the final scan signal and transmit the final scan signal to the signal controller. The display device further includes a power supply configured to supply power to the scan driver.

The signal controller may be configured to determine that the scan driver is normally driven when the final scan signal is output at a reference time. The signal controller may be configured to apply a power enable signal as an ON voltage to a power supply for supplying power to the scan driver when the scan driver is normally driven.

The signal controller may be configured to determine that the scan driver is abnormally driven when the final scan signal is output at a time other than a reference time. The signal controller may be configured to apply a power enable signal as an OFF voltage to the power supply for supplying power to the scan driver when the scan driver is abnormally driven. The power supply intercepts the power supplied to the scan driver when the power enable signal is applied as the OFF voltage.

According to some embodiments, a method for driving a display device including a scan driver and a controller is disclosed. The method includes sequentially outputting a plurality of scan signals to a plurality of scan lines that are connected to a plurality of pixels, controlling the scan driver, receiving a final scan signal that is output at the last time from among the scan signals, detecting output timing of the final scan signal, and determining whether the scan driver is normally driven.

The method includes controlling a voltage level of the final scan signal and transmitting it to the signal controller. detecting of output timing of the final scan signal and the determining of whether the scan driver is normally driven may include determining that the scan driver is normally driven when the final scan signal is output at a reference time.

The method may also include applying a power enable signal as an ON voltage to a power supply for supplying power to the scan driver when the scan driver is determined to be normally driven. The final scan signal and the determining of whether the scan driver is normally driven may include determining that the scan driver is abnormally driven when the final scan signal is output at a time other than a reference time.

The method may also include applying a power enable signal as an OFF voltage to a power supply for supplying power to the scan driver when the scan driver is determined to be abnormally driven. The method may also include intercepting the power supplied to the scan driver as the power enable signal is applied as the OFF voltage.

According to some embodiments, a display error caused by a fault of the scan circuit can be preemptively prevented.

The drawings and the detailed description described above are examples for the present invention and are provided to explain the present invention, and the scope of the present invention described in the claims is not limited thereto. Therefore, it is understood that various modifications and other equivalent exemplary embodiments may be possible by those who are skilled in the art. Accordingly, the actual scope of the present invention must be determined by the spirit of the appended claims.

What is claimed is:

1. A display device comprising:
a display including a plurality of pixels connected to a plurality of scan lines and a plurality of data lines;
a scan driver configured to sequentially apply a plurality of scan signals to the scan lines; and
a signal controller configured to control the scan driver, receive a final scan signal from among the scan signals that is output by the scan driver, detect output timing of the final scan signal, and determine an error based on the detected output timing.

2. The display device of claim 1, further comprising a level controller configured to control a voltage level of the final scan signal and transmit the final scan signal to the signal controller.

3. The display device of claim 1, further comprising a power supply for supplying power to the scan driver.

4. The display device of claim 1, wherein the signal controller is further configured to determine that the scan driver is normally driven when the final scan signal is output at a reference time or within a reference time window.

5. The display device of claim 4, wherein the signal controller is further configured to apply a power enable signal as an ON voltage to a power supply for supplying power to the scan driver when the scan driver is normally driven.

6. The display device of claim 1, wherein the signal controller is further configured to determine that the scan driver is abnormally driven when the final scan signal is output at a time other than a reference time or outside of a reference time window.

7. The display device of claim 6, wherein the signal controller is further configured to apply a power enable signal as an OFF voltage to the power supply for supplying power to the scan driver when the scan driver is abnormally driven.

8. The display device of claim 7, wherein the power supply is configured to halt the power supplied to the scan driver when the power enable signal is applied as the OFF voltage.

9. A method for driving a display device, the method comprising:
outputting a plurality of scan signals via a scan driver to a plurality of scan lines that are connected to a plurality of pixels;
receiving a final scan signal that is output from among the scan signals;
detecting output timing of the final scan signal; and
determining an error based on the detected output timing.

10. The method of claim 9, further comprising controlling a voltage level of the final scan signal and transmitting it to the signal controller.

11. The method of claim 9, wherein the detecting of output timing of the final scan signal and the determining of whether the scan driver is normally driven include determining that the scan driver is normally driven when the final scan signal is output at a reference time.

12. The method of claim 11, further comprising applying a power enable signal as an ON voltage to a power supply for supplying power to the scan driver when the scan driver is determined to be normally driven.

13. The method of claim 9, wherein the detecting of output timing of the final scan signal and the determining of whether the scan driver is normally driven include determining that the scan driver is abnormally driven when the final scan signal is output at a time other than a reference time.

14. The method of claim 13, further comprising applying a power enable signal as an OFF voltage to a power supply for supplying power to the scan driver when the scan driver is determined to be abnormally driven.

15. The method of claim 14, further comprising halting the power supplied to the scan driver as the power enable signal is applied as the OFF voltage.
